(19) United States
(12) Patent Application Publication
(10) Pub. No.: US 2025/0303334 A1
(43) Pub. Date: Oct. 2, 2025

(54) HONEYCOMB FILTER

(71) Applicant: NGK INSULATORS, LTD., Nagoya-Shi (JP)

(72) Inventors: Ayaka SAKAI, Nagoya-Shi (JP); Hatsune ITO, Nagoya-Shi (JP)

(73) Assignee: NGK INSULATORS, LTD., Nagoya-Shi (JP)

(21) Appl. No.: 19/073,164

(22) Filed: Mar. 7, 2025

(30) Foreign Application Priority Data
Mar. 29, 2024 (JP) 2024-057652

(51) Int. Cl. B01D 46/24

(52) U.S. Cl. CPC B01D 46/24492; B01D 46/24491; B01D 46/2474; B01D 46/249; B01D 2279/30

(57) ABSTRACT

A honeycomb filter includes a pillar-shaped honeycomb structure body having a porous partition wall arranged to surround a plurality of cells; and
a plugging portion provided at an open end on the first end face side or the second end face side of each of the cells, wherein
In a pore diameter distribution of the partition wall obtained by structural analysis, the pore diameter (m) whose cumulative pore volume is 90% of the total pore volume is defined as D90 (m),
In a porous structure of the partition wall obtained by the structural analysis, the average value (m) of the equivalent circle diameter of the neck part having the smallest flow path area of communication pores in the porous structure is defined as an average neck diameter (m), and
the product of the D90 (m) and the average neck diameter (m) is 1.0×10⁻¹⁰ m² or more and 9.0×10⁻¹⁰ m² or less.

This application is based upon and claims the benefit of priority from the prior Japanese Patent Application No. 2024-057652, filed on Mar. 29, 2024, the entire contents of which are incorporated herein by reference.

### TECHNICAL FIELD

The present invention relates to a honeycomb filter. More specifically, the present invention relates to a honeycomb filter having excellent trapping performance.

### DESCRIPTION OF RELATED ART

Conventionally, a honeycomb filter using a honeycomb structure has been known as a filter for trapping particulate matter in exhaust gas emitted from an internal combustion engine such as an automobile engine or a device for purifying toxic gas components such as CO, HC, and NOx (see Patent Documents 1 to 5). The honeycomb structure has a partition wall made of porous ceramics such as cordierite, and a plurality of cells are defined by the partition wall. A honeycomb filter includes such a honeycomb structure provided with a plugging portion so as to plug the open ends at the inflow end face side and the outflow end face side of the plurality of cells alternately. In other words, the honeycomb filter has a structure in which inflow cells having the inflow end face side open and the outflow end face side plugged and outflow cells having the inflow end face side plugged and the outflow end face side open are arranged alternately with the partition wall therebetween. In the honeycomb filter, the porous partition wall serves as a filter for trapping particulate matter in exhaust gas. Hereinafter, the particulate matter contained in exhaust gas may be referred to as “PM”. The “PM” is an abbreviation for “Particulate Matter.”

The purification of exhaust gas by the honeycomb filter is performed as follows. First, the honeycomb filter is arranged such that its inflow end face side is located upstream in the exhaust system from which exhaust gas is emitted. Exhaust gas flows into the inflow cell from the inflow end face side of the honeycomb filter. Exhaust gas flowing into the inflow cell passes through the porous partition wall, flows into the outflow cell, and is emitted from the outflow end face of the honeycomb filter. When passing through the porous partition wall, PM or the like in exhaust gas is trapped and removed.
[Patent Document 1] JP-B-5507575
[Patent Document 2] JP-B-5469335
[Patent Document 3] JP-B-5518327
[Patent Document 4] JP-B-5372494
[Patent Document 5] JP-B-6004150

The honeycomb filter used for purifying exhaust gas emitted from an automobile engine has a porous partition wall having a high porosity and a porous material having a high porosity. In recent years, trapping performance of the honeycomb filter has been required to be further improved due to, for example, the strengthening of automotive exhaust gas regulations.

Conventionally, in order to improve trapping performance of the honeycomb filter, for example, the average pore diameter and the pore diameter distribution of the porous partition wall have been controlled. For example, in order to control the pore diameter distribution, attempts have been made to improve the trapping performance of the honeycomb filter by adjusting the average pore diameter described above and adjusting the value of the pore diameter D90 at which the cumulative pore volume is 90% of the total pore volume.

PM such as soot in exhaust gas is trapped by pores of the porous partition wall constituting the honeycomb filter, and in particular, a neck part where a flow path area in the pores of the partition wall is narrowed may affect the trapping performance. Conventionally, the average pore diameter and the pore diameter distribution of the partition wall have been measured by mercury press-in method with a mercury porosimeter or the like. However, in a conventional measuring method with a mercury porosimeter or the like, information on the diameter of the neck part (hereinafter, also referred to as “neck diameter”) in the pores in the partition wall cannot be obtained. For this reason, it is not always possible to realize an adequate improvement in trapping performance by simply controlling parameters such as the average pore diameter and the pore diameter distribution, which have been defined in the prior art, and it has been desired to develop a new technique for improving trapping performance of the honeycomb filter.

### SUMMARY OF THE INVENTION

The present invention has been made in view of the problems with the prior arts described above. According to the present invention, a honeycomb filter having excellent trapping performance is provided.

According to the present invention, a honeycomb filter described below is provided.

[1] A honeycomb filter including: a pillar-shaped honeycomb structure body having a porous partition wall arranged so as to surround a plurality of cells which serve as fluid through channels extending from a first end face to a second end face; and
a plugging portion provided at an open end on the first end face side or the second end face side of each of the cells, wherein
in a pore diameter distribution of the partition wall obtained by structural analysis, the pore diameter (m) whose cumulative pore volume is 90% of the total pore volume is defined as D90 (m),
in a porous structure of the partition wall obtained by the structural analysis, the average value (m) of the equivalent circle diameter of the neck part having the smallest flow path area of communication pores in the porous structure is defined as an average neck diameter (m), and
the product of the D90 (m) and the average neck diameter (m) is 1.0×10⁻¹⁰ m² or more and 9.0×10⁻¹⁰ m² or less.

[2] The honeycomb filter according to [1], wherein the D90 (m) is 1.0×10⁻⁵ m or more and 8.0×10⁻⁵ m or less.

[3] The honeycomb filter according to [1] or [2], wherein the average neck diameter (m) is 5.0×10⁻⁶ m or more and 1.7×10⁻⁵ m or less.

[4] The honeycomb filter according to any one of [1] to [3], wherein in the pore diameter distribution of the partition wall obtained by the structural analysis, a pore diameter (m) in which the cumulative pore volume is 10% of the total pore volume is defined as D10 (m), and
the D10 (m) is 5.0×10⁻⁶ m or more and 2.5×10⁻⁵ m or less.

[5] The honeycomb filter according to any one of [1] to [4], wherein in the pore diameter distribution of the partition wall obtained by the structural analysis, a pore diameter (m) in which the cumulative pore volume is 50% of the total pore volume is defined as D50 (m), and
the D50 (m) is 1.7×10⁻⁵ m or more and 4.1×10⁻⁵ m or less.

[6] The honeycomb filter according to any one of [1] to [5], wherein a porosity (%) of the partition wall obtained by the structural analysis is 33% or more and 65% or less.

The honeycomb filter of the present invention is intended to be effective in excellent trapping performance. That is, in the honeycomb filter of the present invention, the value of D90 in the pore diameter distribution of the partition wall obtained by the structural analysis and the value of the average neck diameter in the porous structure of the partition wall are combined to realize a porous structure extremely suitable for trapping performance based on the parameters highly correlated with trapping performance. The neck diameter in the porous structure of the partition wall is an effective parameter for improving trapping performance, and the present disclosure employs a method of structural analysis to directly measure such a neck diameter.

### BRIEF DESCRIPTION OF DRAWINGS

FIG. 1 is a perspective view schematically showing an embodiment of the honeycomb filter in accordance with the present invention as viewed from an inflow end face side.

FIG. 2 is a plan view of the honeycomb filter shown in FIG. 1 as viewed from the inflow end face side.

FIG. 3 is a sectional view schematically showing a section taken along line A-A′ of FIG. 2.

FIG. 4 is a diagram showing an example of a gray value diagram used for determining a pore diameter distribution of the partition wall.

### DETAILED DESCRIPTION

The following will describe embodiments of the present invention; however, the present invention is not limited to the following embodiments. Therefore, it should be understood that those created by adding changes, improvements or the like to the following embodiments, as appropriate, on the basis of the common knowledge of one skilled in the art without departing from the spirit of the present invention are also covered by the scope of the present invention.

### (1) Honeycomb Filter:

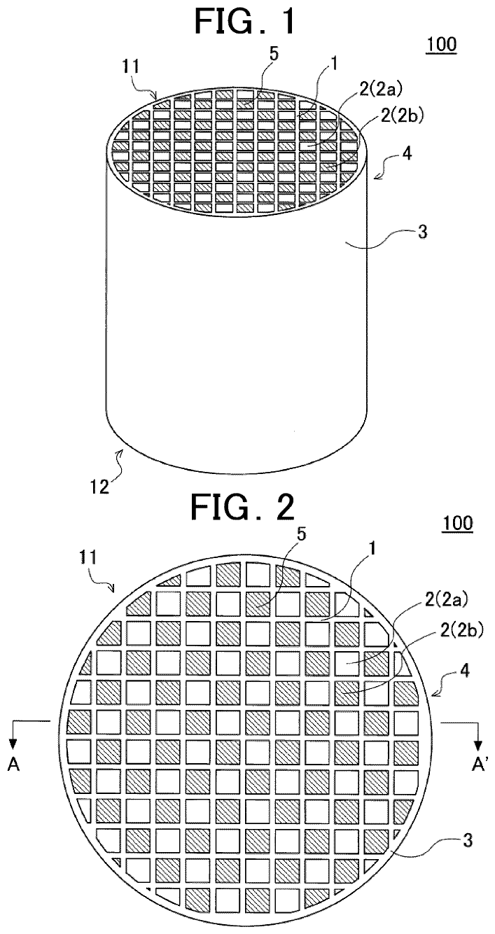

As shown in FIGS. 1 to 3, the first embodiment of the honeycomb filter in accordance with the present invention is a honeycomb filter 100 that includes a honeycomb structure body 4 and plugging portions 5. The honeycomb structure body 4 is a pillar-shaped structure having a porous partition wall 1 disposed so as to surround a plurality of cells 2 that serve as fluid through channels extending from a first end face 11 to a second end face 12. In the honeycomb filter 100, the honeycomb structure body 4 is pillar-shaped and further includes a circumferential wall 3 on the outer peripheral side surface. In other words, the circumferential wall 3 is provided to encompass the partition wall 1 provided in a grid pattern.

The plugging portions 5 are disposed at open ends on the first end face 11 side or the second end face 12 side of each of the cells 2. In the honeycomb filters 100 shown in FIGS. 1 to 3, the plugging portions 5 are disposed at open ends on the first end face 11 side of the predetermined cells 2 and open ends on the second end face 12 side of the remaining cells 2, respectively. When the first end face 11 is an inflow end face and the second end face 12 is an outflow end face, the cell 2 in which the plugging portion 5 is disposed at an open end on the outflow end face side and the inflow end face side is opened is defined as an inflow cell 2a. Further, the cell 2 in which the plugging portion 5 is disposed at an open end on the inflow end face side and the outflow end face side is opened is defined as an outflow cell 2b. The inflow cells 2a and the outflow cells 2b are preferably disposed alternately with the partition wall 1 therebetween. Then, it is preferable that a checkerboard pattern is thereby formed by the plugging portions 5 and “the open ends of the cells 2” on both end faces of the honeycomb filter 100.

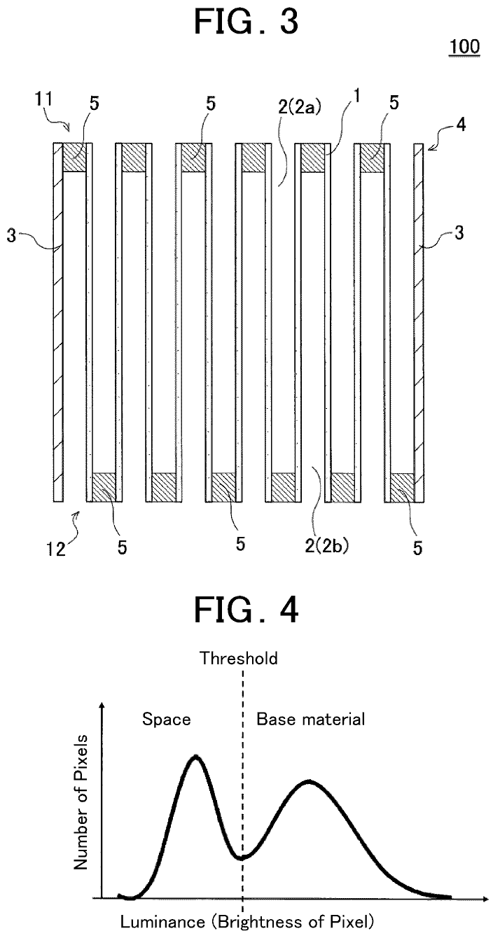

FIG. 1 is a perspective view schematically showing an embodiment of the honeycomb filter of the present invention as viewed from an inflow end face side. FIG. 2 is a plan view of the honeycomb filter shown in FIG. 1 as viewed from the inflow end face side. FIG. 3 is a sectional view schematically showing a section taken along line A-A′ of FIG. 2.

The honeycomb filter 100 has a characteristic structure with respect to the porous structure of the partition wall 1 constituting the honeycomb structure body 4. Here, in the pore diameter distribution of the partition wall 1 obtained by the structural analysis of the honeycomb filter 100, the pore diameter (m) in which the cumulative pore volume is 90% of the total pore volume is defined as D90 (m). Further, in the porous structure of the partition wall 1 obtained by the above structural analysis, the average value (m) of the equivalent circle diameters of the neck part having the smallest flow path area of communication pores in the porous structure is defined as an average neck diameter (m). The honeycomb filter 100 is mainly configured such that the product of the D90 (m) and the average neck diameter (m) is 1.0×10⁻¹⁰ m² or more and 9.0×10⁻¹⁰ m² or less.

Hereinafter, in the present specification, unless otherwise specified, the “pore diameter distribution of the partition wall 1” means the “pore diameter distribution of the partition wall” obtained by the structural analysis of the honeycomb filter 100 described above.

Similarly, the “porous structure of the partition wall 1” means, unless otherwise specified, the “porous structure of the partition wall 1” obtained by the structural analysis of the honeycomb filter 100 described above.

Further, the equivalent circle diameter of the neck part having the smallest flow path area of the communication pore in the porous structure of the partition wall 1 may be referred to as a “neck diameter (m)”.

In the present specification, fine holes in the porous structure are referred to as “pore” or “pores”, and in particular, the hole (pore) that allows communication between two neighboring cells 2 and 2 partitioned by the partition wall 1 is referred to as a “communication pore”.

The honeycomb filter 100 is intended to be effective in excellent trapping performance. That is, in the honeycomb filter 100, the value of D90 (m) in the pore diameter distribution of the partition wall 1 and the value of the average neck diameter (m) in the porous structure of the partition wall 1 are combined to realize a porous structure extremely suitable for trapping performance based on the parameters highly correlated with trapping performance. The neck diameter (m) in the porous structure of the partition wall 1 is an effective parameter for improving trapping performance, and the honeycomb filter 100 of the present embodiment employs a particular method of structural analysis to directly measure such a neck diameter. In the honeycomb filter 100 of the present embodiment, as described above, as a parameter highly correlated with trapping performance, the value of the product of D90 (m) and the average neck diameter (m) is adopted. For example, particulate matter (PM) contained in exhaust gas or the like is not all trapped at the neck part, and thus the smaller the space behind the neck part, the easier PM is to be trapped. Therefore, the value of the average neck diameter alone did not show a significant correlation with trapping performance.

When the above-described product of D90 (m) and the average neck diameter (m) is less than 1.0×10⁻¹⁰ m², it is not preferable in that pressure loss performance is deteriorated or that the catalyst is easily clogged in the neck part. On the other hand, when the product of D90 (m) and the average neck diameter (m) exceeds 9.0×10⁻¹⁰ m², trapping performance deteriorates. The product of D90 (m) and the average neck diameter (m) may be 1.0×10⁻¹⁰ m² or more and 9.0×10⁻¹⁰ m² or less, and is preferably, for example, 3.0×10⁻¹⁰ m² or more and 7.0×10⁻¹⁰ m² or less.

The value of D90 (m) is not particularly limited, but is preferably, for example, 1.0×10⁻⁵ m or more and 8.0×10⁻⁵ m or less, more preferably 3.0×10⁻⁵ m or more and 7.0×10⁻⁵ m or less. With this configuration, trapping performance of the honeycomb filter 100 can be further improved. For example, by setting D90 (m) in the pore diameter distribution to be low to reduce large pores, the flow rate of the fluid permeating through the partition wall 1 can be suppressed from locally increasing, and filtration efficiency of the honeycomb filter 100 can be improved.

Further, the value of the average neck diameter (m) in the porous structure of the partition wall 1 is not particularly limited, but is preferably 5.0×10⁻⁶ m or more and 1.7×10⁻⁵ m or less, more preferably 1.0×10⁻⁵ m or more and 1.6×10⁻⁵ m or less. With this configuration, trapping performance of the honeycomb filter 100 can be further improved. Similar to the D90 (m), smaller values of the average neck diameter (m) are also effective in improving trapping performance.

In the present disclosure, the “pore diameter distribution of the partition wall 1 obtained by the structural analysis” means a pore diameter distribution obtained by the structural analysis by the following analysis method. In other words, it means the pore diameter distribution obtained by analysis using “Identify Pores function” which is one of the interface modules of “GeoDict (trade name (the same shall apply hereinafter)” which is the microstructure simulation software developed by Math2Market GmbH Co. of Germany.

Hereinafter, the “analysis method using Identify Pores function” is sometimes referred to as “Identify Pores analysis method”. Therefore, the “pore diameter distribution of the partition wall 1” in the honeycomb filter 100 of the present embodiment refers to the pore diameter distribution of the partition wall 1 obtained by Identify Pores analysis method. The pore diameter distribution of the partition wall 1 obtained by Identify Pores analysis method can more accurately analyze the pore diameter inside the partition wall 1. That is, even when there is a part where the diameter of the pore is enlarged or a part where the diameter of the pore is narrowed (that is, a neck part), the pore diameters thereof can be appropriately determined. Therefore, a pore diameter inside the partition wall 1, in particular, a pore diameter inside the neck part of the pore, which is difficult to accurately measure by the conventional mercury press-in method, can be obtained more accurately.

Here, “Identify Pores analysis method” for obtaining the pore diameter distribution of the partition wall 1 will be described. Hereinafter, the “Identify Pores analysis method” may be simply referred to as the “present analysis method”. In the present analysis method, a partition wall 1 of the honeycomb filter 100 is subjected to tomography using an X-ray CT device, and the pore diameter distribution of the partition wall 1 is obtained from a partition wall structure model obtained by the three-dimensionally converting the acquired tomographic image.

Specifically, first, a part of the partition wall 1 is cut out from the honeycomb filter 100 to prepare a partition wall sample piece for analysis. However, the part where a plugging portion 5 is present shall be excluded from the partition wall sample piece. The partition wall sample piece is collected at a center position both in a direction extending from the first end face 11 to the second end face 12 of the honeycomb filter 100 (hereinafter, also referred to as an “axial direction X”) and in a direction perpendicular to the axial direction X. The partition wall sample piece has a rectangular parallelepiped shape in which a length in the axial direction X is about 1 cm, a width in a front surface direction of the partition wall 1 orthogonal to the axial direction X is about 0.5 cm, and a thickness orthogonal to both the length and the width is a thickness of the partition wall 1.

Next, the prepared partition wall sample piece is used as an X-ray CT imaging sample. Here, “CT” is an abbreviation for Computed Tomography. The X-ray CT device is used to acquire continuous tomographic images of the sample at the following imaging conditions: voltage: 60 kV, lens: 4×, filter: LE1, and resolution: 1.2 μm/pixel. As the X-ray CT device, for example, Xradia520Versa (trade name) manufactured by Zeiss Corporation can be used. The image file format of the continuous tomographic image is not particularly limited as long as the image file format can be used in the present analysis method. For example, the acquired continuous tomographic image may be a continuous tomographic image in the form of TIFF (Tagged Image File Format) or a continuous tomographic image in the form of BMP (Bitmap).

In the following, a case where a continuous tomographic image in the form of TIFF is acquired will be described. The obtained continuous tomographic images in the form of TIFF are read at 1.2 μm/voxel using “ImportGeo function” which is one of the modules of “GeoDict” which is the microstructure simulation software developed by Math2Market GmbH Co.

Next, in order to separate the skeleton part and the space part of the read images, the partition wall sample piece is three-dimensionally modeled using the intersection part when separating into two peaks in the gray value diagram as shown in FIG. 4 as a threshold.

Then, noises in the three-dimensional model are removed, and the unnecessary parts are removed so as to be in 400 voxel×400 voxel×partition wall thickness voxel. Next, the size of the pore in the three-dimensional partition wall structural model M is derived using “Identify Pores function” of “PoroDict function” which is one of the modules of GeoDict. The computation method by Identify Pores function in GeoDict is a method of performing WaterShed segmentation on the pores.

By analyzing the partition wall structural model M with Identify Pores function described above, the pore diameter distribution and values of above-described D10 (m), D50 (m), and D90 (m) can be obtained. Note that “Identify Pores function (2020 edition)” in the above modules of “GeoDict” is used as the “Identify Pores function”. The “Identify Pores function (2020 edition)” indicates the year (Christian era) in which this Identify Pores function was provided. Therefore, the present analysis method is based on the analysis results using Identify Pores function provided in 2020 A. D. Here, the 2020 edition indicates the year (Christian era) provided in Japan, but this does not apply to cases where it is clear that the same analysis results are obtained. If it is obvious that the Identify Pores function provided in other than 2020 (e.g., before or after 2020) can obtain the same analysis results as Identify Pores function (2020 edition) described above, the analyses may be performed using them.

In the honeycomb filter 100 of the present embodiment, in a pore diameter distribution of the partition wall 1 obtained by the present analysis method described above, a pore diameter (m) whose cumulative pore volume is 90% of the total pore volume is defined as D90 (m). In addition, in the pore diameter distribution of the partition wall 1 obtained by the present analysis method, a pore diameter (m) whose cumulative pore volume is 10% of the total pore volume is defined as D10 (m), and a pore diameter (m) whose cumulative pore volume is 50% of the total pore volume is defined as D50 (m).

The average neck diameter (m) of the porous structure of the partition wall 1 can be determined by the following method based on the present analysis method described above. First, the pores in the partition wall structural model M are performed WaterShed segmentation by analyzing the partition wall structural model M with Identify Pores function. At this time, the pores at the end of the area are removed, and the smallest pore diameter detected is 2 voxel. When the ratio of the interfaces of two pores contacting each other accounts for 30% or more of the surface area of the pores themselves, the two pores are integrated into one pore. Subsequently, 2 voxel around the pores is replaced with another material using Dilate function of ProcessGeo module (2020 edition) in order from the smaller pore ID of the divided pores, thereby obtaining the contacting surface of the divided pore part. The average of the neck diameters (average neck diameters) is obtained by performing WaterShed segmentation again at the contacting surface of the divided pores and taking the number average. Note that the WaterShed segmentation means division of an area using a WaterShed algorithm.

In the pore diameter distribution of the partition wall 1 obtained by the present analysis method, although not particularly limited, D10 (m) is preferably 5.0×10⁻⁶ m or more and 2.5×10⁻⁵ m or less, more preferably 1.0×10⁻⁵ m or more and 2.3×10⁻⁵ m or less. By setting D10 (m) to the above-described numerical range, it is advantageous in improving filtration efficiency, improving catalytic coatability, and suppressing an increase in pressure loss. For example, by setting D10 (m) to 5.0×10⁻⁶ m or more, it is preferable in that the pressure loss performance is improved or the catalyst can easily enter inside the partition wall. On the other hand, by setting D10 (m) to 2.5×10⁻⁵ m or less, trapping performance is preferably improved.

Further, in the pore diameter distribution of the partition wall 1 obtained by the present analysis method, D50 (m) is preferably 1.7×10⁻⁵ m or more and 4.1×10⁻⁵ m or less, more preferably 1.9×10⁻⁵ m or more and 3.9×10⁻⁵ m or less. By setting D50 (m) to the above-described numerical range, it is advantageous in improving filtration efficiency and suppressing an increase in pressure loss. For example, by setting D10 (m) to D50 (m) to 1.7×10⁻⁵ m or more, it is preferable in that the pressure loss performance is improved. On the other hand, by setting D50 (m) to 4.1×10⁻⁵ m or less, trapping performance is preferably improved.

The honeycomb filter 100 preferably has a porosity of the partition wall 1 of 33% or more and 65% or less. In the present disclosure, the porosity of the partition wall 1 is a value determined by structural analysis. Specifically, the porosity of the partition wall 1 is a value measured by Open and Closed Porosity method out of the “PoroDict function”, which is one of the modules of the “GeoDict” described above. When the porosity of the partition wall 1 is set to 33% or more and 65% or less, pressure loss can be reduced. When the porosity of the partition wall 1 is set to 33% or more, pressure loss of the honeycomb filter 100 can be sufficiently reduced. On the other hand, when the porosity of the partition wall 1 is set to 65% or less, the mechanical strength of the honeycomb filter 100 can be sufficiently maintained. The porosity of the partition wall 1 is more preferably 35% or more and 60% or less. It should be noted that the partition wall structural model M in determining the porosity of the partition wall 1 can be obtained in the same manner as the “Identify Pores analysis method” for obtaining the pore diameter distribution of the partition wall 1 described above.

The thickness of the partition wall 1 is not particularly limited, but is preferably, for example, 178 μm or more and 254 μm or less, and particularly preferably 191 μm or more and 241 μm or less. The thickness of the partition wall 1 can be measured with a scanning electron microscope or a microscope, for example. If the thickness of the partition wall 1 is too thin, it is not preferable in terms of trapping performance degradation. On the other hand, if the thickness of the partition wall 1 is too thick, it is not preferable in terms of increasing pressure loss.

The cell density of the cell 2 defined by the partition wall 1 is preferably 43 cells/cm² or more and 57 cells/cm² or less, more preferably 47 cells/cm² or more and 54 cells/cm² or less. With this configuration, the honeycomb filter 100 can be favorably used as a filter for purifying exhaust gas emitted from an automobile engine.

The shape of the cells 2 formed in the honeycomb structure body 4 is not particularly limited. For example, the shapes of the cells 2 in a section that is orthogonal to the extending direction of the cells 2 may be polygonal, circular, elliptical or the like. Examples of the polygonal shape include a triangle, a quadrangle, a pentagon, a hexagon, and an octagon. The shape of the cells 2 is preferably a triangle, a quadrangle, a pentagon, a hexagon, or an octagon. In the present invention, the cells 2 mean the spaces surrounded by the partition wall 1.

Regarding the shape of the cells 2 formed in the honeycomb structure body 4, all the cells 2 may have the same shape or different shapes. For example, although not shown, quadrangular cells and octagonal cells may be mixed. For example, the shape of the outflow cell may be different from the shape of the inflow cell in a section orthogonal to the extending direction of the cells of the honeycomb structure body. In such an embodiment, for example, it is preferable that the shape of the outflow cell is one of a quadrangle and an octagon, and the shape of the inflow cell is the other of a quadrangle and an octagon.

In addition, regarding the size of the cells 2 formed in the honeycomb structure body 4, all the cells 2 may have the same or different sizes. For example, although not shown, among the plurality of cells, some cells may be made to be large, and other cells may be made to be relatively smaller.

The circumferential wall 3 of the honeycomb structure body 4 may be configured integrally with the partition wall 1 or may be composed of a circumferential coat layer formed by applying a circumferential coating material to the circumferential side of the partition 1. For example, although not shown, the circumferential coat layer can be provided on the circumferential side of the partition wall after the partition wall and the circumferential wall are integrally formed and then the formed circumferential wall is removed by a publicly known method, such as grinding, in a manufacturing process.

The shape of the honeycomb structure body 4 is not particularly limited. The shape of the honeycomb structure body 4 can be a pillar-shape in which the shapes of the first end face 11 (e.g., the inflow end face) and the second end face 12 (e.g., the outflow end face) includes a circular shape, an elliptical shape, a polygonal shape or the like.

The size of the honeycomb structure body 4, for example, the length from the first end face 11 to the second end face 12, and the size of a section orthogonal to the extending direction of the cells 2 of the honeycomb structure body 4, is not particularly limited. Each size may be selected as appropriate such that optimum purification performance is obtained when the honeycomb filter 100 is used as a filter for purifying exhaust gas.

The material of the partition wall 1 is not particularly limited, and any porous material may be used as long as it satisfies the above-described porous structure of the partition wall 1. For example, the material of the partition wall 1 preferably contains at least one selected from the group consisting of silicon carbide, cordierite, silicon-silicon carbide composite material, cordierite-silicon carbide composite material, silicon nitride, mullite, alumina, and aluminum titanate. The material constituting the partition wall 1 is preferably a material including 90% by mass or more of the materials listed in the above group, and is more preferably a material including 92% by mass or more of the materials listed in the above group, and is particularly preferably a material including 95% by mass or more of the materials listed in the above group. The silicon-silicon carbide composite material is a composite material formed using silicon carbide as an aggregate and silicon as a bonding material. The cordierite-silicon carbide composite material is a composite material formed using silicon carbide as an aggregate and cordierite as a bonding material. In the honeycomb filter 100 of the present embodiment, the material constituting the partition wall 1 is particularly preferably cordierite.

The material of the plugging portions 5 is preferably a material that is preferred as the material of the partition wall 1. The material of the plugging portions 5 and the material of the partition wall 1 may be the same or different.

In the honeycomb filter 100, the partition wall 1 defining the plurality of cells 2 is preferably loaded with a catalyst for purifying exhaust gas. Loading the partition wall 1 with a catalyst refers to coating the catalyst onto the surface of the partition wall 1 and the inner walls of the pores formed in the partition wall 1. This configuration makes it possible to convert CO, NOx, HC and the like in exhaust gas into harmless substances through a catalytic reaction. In addition, the oxidation of PM of trapped soot or the like can be accelerated. In the honeycomb filter 100 of the present embodiment, it is particularly preferable that the catalyst is loaded inside the pores of the porous partition wall 1. With such a configuration, it is possible to achieve both improvement in trapping performance and reduction in pressure loss after loading the catalyst at low catalyst amounts. Further, after loading the catalyst, the flow of gases becomes uniform, so that the purification performance can be expected to be improved.

The catalyst with which the partition wall 1 is loaded is not particularly limited. For example, a catalyst containing a platinum group element and containing an oxide of at least one element among aluminum, zirconium, and cerium can be exemplified.

### (2) Manufacturing Method of Honeycomb Filter

Next, a manufacturing method of the honeycomb filter of the present embodiment will be described. The honeycomb filter of the present embodiment can be manufactured, for example, by the following methods. First, a plastic kneaded material is prepared to make a honeycomb structure body. The kneaded material for making honeycomb structure body can be prepared, for example, as follows. Talc, kaolin, alumina, aluminum hydroxide, and porous silica are used as raw material powders, and water-absorbing polymer, binder, surfactant, and water as organic pore formers are added to prepare a plastic kneaded material. In particular, by adjusting the blending ratio of raw material powder and the organic pore former in the preparation of the kneaded material, the obtained partition wall can have a pore diameter distribution that satisfies the D90 (m) and the average neck diameter (m) of the porous structure described so far.

Next, the kneaded material thus obtained is subjected to extrusion so as to make a honeycomb formed body having a partition wall defining a plurality of cells, and an outer wall disposed to encompass the partition wall.

The obtained honeycomb formed body is dried by, for example, microwave and hot air, and open ends of the cell are plugged using the same material as the material used for making honeycomb formed body, thereby making plugging portions. The honeycomb formed body may be further dried after making the plugging portions.

Next, a honeycomb filter is manufactured by firing the honeycomb formed body in which the plugging portions were made. A firing temperature and a firing atmosphere are different depending on the raw material, and those skilled in the art can select the firing temperature and the firing atmosphere that are the most suitable for the selected material.

According to the manufacturing method described above, it is possible to manufacture a honeycomb filter having a partition wall in which the porous structure described above (i.e., D90 and average neck diameter) is realized.

### EXAMPLES

The following describes the present invention more specifically by examples, but the present invention is not at all limited by those examples.

### Example 1

Talc, kaolin, alumina, aluminum hydroxide, water-absorbing polymers and porous silica were prepared as a forming raw material for preparing kneaded material. In Example 1, the forming raw material was prepared so that the blending ratio of each raw material was adjusted to have a chemical composition in the range of 42 to 56% by mass of silica, 30 to 45% by mass of alumina, and 12 to 16% by mass of magnesia.

Next, a kneaded material was prepared by adding 2 parts by mass of a water-absorbing polymer as a pore former, 6 parts by mass of a binder, and 1 part by mass of a dispersing agent to 100 parts by mass of the forming raw material excluding the water-absorbing polymer. As a pore former, a water-absorbing polymer having an average particle diameter of 20 μm was used. Methylcellulose (Methylcellulose) was used as the binder. A potassium laurate soap was used as a dispersing agent.

Next, the obtained kneaded material was molded using an extruder to make a honeycomb formed body. Next, the obtained honeycomb formed body was dried by high frequency dielectric heating, and then further dried using a hot air dryer. The shape of the cells in the honeycomb formed body was quadrangular.

Next, plugging portions were formed in the dried honeycomb formed body. First, the inflow end face of the honeycomb formed body was masked. Next, the end portion provided with the mask (the end portion on the inflow end face side) was immersed in the plugging slurry, and the open ends of the cells without the mask (the outflow cells) were filled up with the plugging slurry. In this way, the plugging portions were formed on the inflow end face side of the honeycomb formed body. Then, the plugging portions were also formed in the inflow cells in the same manner for the outflow end face of the dried honeycomb formed body.

Next, the honeycomb formed body in which the plugging portions have been formed was dried in a microwave dryer, and further dried completely with a hot air dryer, and then both end faces of the honeycomb formed body were cut and adjusted to a predetermined size. The dried honeycomb formed body was then degreased and fired to manufacture the honeycomb filter of Example 1.

The honeycomb filter of Example 1 had an end face diameter of 304 mm and a length in the extending direction of the cells of 100 mm. In addition, the partition wall had a thickness of 243 μm and a cell density of 54 cells/cm².

For the honeycomb filter of Example 1, a porosity of the partition wall was measured in the following manner. The porosity of the partition wall was 53.2%.

### (Porosity)

The Porosity of the partition wall was measured using Open and Closed Porosity of PoroDict function, which is one of GeoDict modules. Specific analysis method is as described in the present embodiment. The three-dimensional model and the partition wall structural model M were obtained in the same manner as the “Identify Pores analysis method” for obtaining pore diameter distribution described in the present embodiment.

Further, a pore diameter distribution of the partition wall in the honeycomb filter of Example 1 was determined by Identify Pores analysis method, and the values of D10 (m), D50 (m), and D90 (m) were determined based on the obtained pore diameter distribution (analyzed values). Note that D10 (m) represents the pore diameter (m) at which the cumulative pore volume is 10% of the total pore volume. D50 (m) represents the pore diameter (m) at which the cumulative pore volume is 50% of the total pore volume. D90 (m) represents the pore diameter (m) at which the cumulative pore volume is 90% of the total pore volume. A series of analyses by Identify Pores analysis method was performed by the method described so far, and “GeoDict (trade name)” which is a microstructure simulation software developed by Math2Market GmbH Co. was used in the analysis. In addition, the average neck diameter of the partition wall was determined by the above-described analysis method. The determined values of D10 (m), D50 (m), D90 (m), and average neck diameter (m) are shown in Table 1. In addition, the “product of D90 (m) and the average neck diameter (m)” was calculated from the values of D90 (m) and the average neck diameter (m). The results are shown in the column “D90×Average neck diameter (m²)” in Table 1.

TABLE 1

| | | | | | | | Trapping |
|---|---|---|---|---|---|---|---|
| | | | D90 × | | | | performance |
| | D90 | Average neck | Average neck | D50 | D10 | Porosity | Soot emission |
| | (m) | diameter (m) | diameter (m²) | (m) | (m) | (%) | (kg/m³) |
| Example 1 | 3.4 × 10⁻⁵ | 1.0 × 10⁻⁵ | 3.4 × 10⁻¹⁰ | 1.9 × 10⁻⁵ | 1.0 × 10⁻⁵ | 53.2 | 2.3 × 10⁻¹⁰ |
| Example 2 | 5.9 × 10⁻⁵ | 1.5 × 10⁻⁵ | 9.0 × 10⁻¹⁰ | 3.9 × 10⁻⁵ | 2.2 × 10⁻⁵ | 35.3 | 1.7 × 10⁻⁸ |
| Example 3 | 6.7 × 10⁻⁵ | 1.2 × 10⁻⁵ | 8.2 × 10⁻¹⁰ | 3.3 × 10⁻⁵ | 1.6 × 10⁻⁵ | 57.3 | 2.3 × 10⁻⁹ |
| Example 4 | 4.1 × 10⁻⁵ | 1.4 × 10⁻⁵ | 5.6 × 10⁻¹⁰ | 2.8 × 10⁻⁵ | 1.7 × 10⁻⁵ | 50.0 | 2.4 × 10⁻⁹ |
| Example 5 | 4.6 × 10⁻⁵ | 1.3 × 10⁻⁵ | 5.9 × 10⁻¹⁰ | 2.9 × 10⁻⁵ | 1.6 × 10⁻⁵ | 44.5 | 3.8 × 10⁻⁹ |
| Example 6 | 4.8 × 10⁻⁵ | 1.3 × 10⁻⁵ | 6.4 × 10⁻¹⁰ | 2.9 × 10⁻⁵ | 1.7 × 10⁻⁵ | 43.2 | 6.4 × 10⁻⁹ |
| Example 7 | 5.0 × 10⁻⁵ | 1.3 × 10⁻⁵ | 6.6 × 10⁻¹⁰ | 3.0 × 10⁻⁵ | 1.7 × 10⁻⁵ | 38.3 | 7.8 × 10⁻⁹ |
| Example 8 | 5.5 × 10⁻⁵ | 1.5 × 10⁻⁵ | 8.0 × 10⁻¹⁰ | 3.5 × 10⁻⁵ | 2.1 × 10⁻⁵ | 44.6 | 1.1 × 10⁻⁸ |
| Example 9 | 5.9 × 10⁻⁵ | 1.4 × 10⁻⁵ | 8.0 × 10⁻¹⁰ | 3.5 × 10⁻⁵ | 1.9 × 10⁻⁵ | 36.0 | 1.8 × 10⁻⁸ |
| Comparative Example 1 | 6.3 × 10⁻⁵ | 1.6 × 10⁻⁵ | 1.0 × 10⁻⁹ | 4.0 × 10⁻⁵ | 2.4 × 10⁻⁵ | 45.4 | 2.5 × 10⁻⁸ |
| Comparative Example 2 | 6.3 × 10⁻⁵ | 1.5 × 10⁻⁵ | 9.5 × 10⁻¹⁰ | 4.0 × 10⁻⁵ | 2.3 × 10⁻⁵ | 44.2 | 4.2 × 10⁻⁸ |
| Comparative Example 3 | 6.6 × 10⁻⁵ | 1.6 × 10⁻⁵ | 1.0 × 10⁻⁹ | 4.4 × 10⁻⁵ | 2.4 × 10⁻⁵ | 59.7 | 7.5 × 10⁻⁸ |
| Comparative Example 4 | 7.6 × 10⁻⁵ | 1.6 × 10⁻⁵ | 1.3 × 10⁻⁹ | 5.0 × 10⁻⁵ | 2.8 × 10⁻⁵ | 60.8 | 5.3 × 10⁻⁸ |
| Comparative Example 5 | 9.1 × 10⁻⁵ | 1.7 × 10⁻⁵ | 1.5 × 10⁻⁹ | 5.2 × 10⁻⁵ | 2.7 × 10⁻⁵ | 56.5 | 1.0 × 10⁻⁷ |

On the honeycomb filter of Example 1, the trapping performance was evaluated in the following manner. Table 1 shows the result.

### (Trapping Performance)

The soot emission (kg/m³) was calculated using “FilterDict” which is a function of GeoDict. The three-dimensional porous material data was obtained by “Identify Pores analysis method” for determining pore diameter distribution described in the present embodiment.

### Examples 2 to 9

In Examples 2 to 9, the blending ratio (parts by mass) of the respective raw material used in the cordierite forming raw material was changed as shown below. For the obtained honeycomb filter, the average neck diameter (m) and D90 (m) were determined in the same manner as in Example 1. The results are shown in Table 1. In Examples 2 to 9, the average particle diameter and the blending ratio of water-absorbing polymer or porous silica in the raw material, and the water content to be added were changed.

### Comparative Examples 1 to 5

In Comparative Examples 1 to 5, the blending ratio (parts by mass) of the respective raw material used in the cordierite forming raw material was changed as shown below. For the obtained honeycomb filter, the average neck diameter (m) and D90 (m) were determined in the same manner as in Example 1. The results are shown in Table 1. In Comparative Examples 1 to 3, the average particle diameter and the blending ratio of water-absorbing polymer or porous silica in the raw material, and the water content to be added were changed. In addition, in some comparative examples, a pore forming resin was added to the pore former.

For the honeycomb filters of Examples 2 to 9 and Comparative Examples 1 to 5, the porosity of the partition wall was measured in the same manner as in Example 1. Further, for the honeycomb filters of Example 2 to 9 and Comparative Examples 1 to 5, the pore diameter distribution of the partition wall was determined by Identify Pores analysis method, and the values of D10 (m) and D50 (m) were determined based on the obtained pore diameter distribution (analysis value). The results are shown in Table 1.

The honeycomb filters of Examples 2 to 9 and Comparative Examples 1 to 5 were evaluated for trapping performance in the same manner as in Example 1. Table 1 shows the result.

### Results

The honeycomb filters of Examples 1 to 9 showed excellent performance in the evaluation of the trapping performance. In particular, the honeycomb filter of Example 1 had small D90 (m) and small average neck diameter (m), and thus showed high trapping performance.

On the other hand, the honeycomb filters of Comparative Examples 1 to 5 had lower trapping performance than the honeycomb filters of Examples 1 to 9. For example, the honeycomb filters of Comparative Examples 1 to 3 had smaller D90 values than the honeycomb filter of Example 3, but the results showed poor trapping performance.

### INDUSTRIAL APPLICABILITY

The honeycomb filter according to the present invention can be used as a trapping filter for removing particulates and the like contained in exhaust gas.

### DESCRIPTION OF REFERENCE NUMERALS

1: partition wall, 2: cell, 2a: inflow cell, 2b: outflow cell, 3: circumferential wall, 4: honeycomb structure body, 5: plugging portion, 11: first end face, 12: second end face, 100: honeycomb filter.

1. A honeycomb filter comprising: a pillar-shaped honeycomb structure body having a porous partition wall arranged so as to surround a plurality of cells which serve as fluid through channels extending from a first end face to a second end face; and
a plugging portion provided at an open end on the first end face side or the second end face side of each of the cells, wherein
In a pore diameter distribution of the partition wall obtained by structural analysis, the pore diameter (m) whose cumulative pore volume is 90% of the total pore volume is defined as D90 (m),
In a porous structure of the partition wall obtained by the structural analysis, the average value (m) of the equivalent circle diameter of the neck part having the smallest flow path area of communication pores in the porous structure is defined as an average neck diameter (m), and
the product of the D90 (m) and the average neck diameter (m) is 1.0×10⁻¹⁰ m² or more and 9.0×10⁻¹⁰ m² or less.

2. The honeycomb filter according to claim 1, wherein the D90 (m) is 1.0×10⁻⁵ m or more and 8.0×10⁻⁵ m or less.

3. The honeycomb filter according to claim 1, wherein the average neck diameter (m) is 5.0×10⁻⁶ m or more and 1.7×10⁻⁵ m or less.

4. The honeycomb filter according to claim 1, wherein in the pore diameter distribution of the partition wall obtained by the structural analysis, a pore diameter (m) in which the cumulative pore volume is 10% of the total pore volume is defined as D10 (m), and
the D10 (m) is 5.0×10⁻⁶ m or more and 2.5×10⁻⁵ m or less.

5. The honeycomb filter according to claim 1, wherein in the pore diameter distribution of the partition wall obtained by the structural analysis, a pore diameter (m) in which the cumulative pore volume is 50% of the total pore volume is defined as a D50 (m), and
the D50 (m) is 1.7×10⁻⁵ m or more and 4.1×10⁻⁵ m or less.

6. The honeycomb filter according to claim 1, wherein a porosity (%) of the partition wall obtained by the structural analysis is 33% or more and 65% or less.
